(19) United States
(12) Patent Application Publication
(10) Pub. No.: US 2006/0225125 A1
(43) Pub. Date: Oct. 5, 2006

(54) Terminal device login method and system

(75) Inventors: Shan-Fa Shih, Taipei (TW); Johnny Cui, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/096,771

(22) Filed: Mar. 31, 2005

(51) Int. Cl. G06F 7/04

(52) U.S. Cl. 726/2

(57) ABSTRACT

A terminal device login system and method using the same for managing login allocation process for client computers are proposed. The terminal login device system at least has a detecting unit, a storage unit, a request unit, a processing unit, and a control unit. First, the detecting unit of the system, upon detecting a connection of a client computer to the network, triggers the processing unit to produce a temporary computer name for the client computer to log onto the network. Then, the request unit sends a request to the processing unit for an official name allocation, whereupon the processing unit then selects an unused official name from the storage unit to be used in place of the temporary name. The client computer updates the computer name with the official computer name then proceeds to register in the network for subsequent functional operations.

### FIELD OF THE INVENTION

The present invention relates to a technology for managing and automating the login process for terminal devices, and, more particularly, to a method and a system for allowing users to conveniently log on to a Factory Information System (FIS).

### DESCRIPTION OF THE PRIOR ART

Network technology enables users to utilize network resources, exchange information with others on the network, and receive updated information in real time. In industry, many production departments have adopted computer networking automation technology to perform production management, taking advantage of the simplicity, directness, speed, error-reduction (compared to manual methods), and the flexibility of immediate updates and so on that such technology not only greatly enhances the efficiency and quality of production but also reduces management cost and labor.

However, for each terminal or computer to connect to the network, users must firstly go through a series of network configuration procedures in order for the computer to operate functionally on the network. That is, in order to effectively manage the entire computer network, it is required that its end users, before entering the network to perform any operations, complete network configuring procedures in advance. With existing technology, in order to equip end-user terminals to work on the network, the terminals must first be provided with Factory Information System software (and other software). Such software is typically installed by copying the software from an external or network master drive to the local hard disk drives (HDD) of the terminals being added to the system. Afterwards, service engineers need to individually configure each terminal's network software to establish settings, assign unique computer names, configure IP addresses, and so on.

For the above process, human labor is required for each individual terminal being added to the network; therefore, this process can be quite tedious and time-consuming. On average, each computer installation and configuration takes 30 minutes. Not only that, but due to the fact that the process is done by human labor, it is sometimes the case that the name assigned by the service engineer is already in use and must be revised again. Such a time-intensive process increases operating costs and adversely affects work efficiency.

In light of these problems, the provision of a method and system to provide a simple, highly effective, and fast way to manage the configuration and login of end user computers on a network system is an important need in the field urgently awaiting resolution. Such a method and system should need little or no human intervention and be free from the error of name duplication that sometimes occurs during the configuring process. Such a system would improve work-efficiency and lower costs.

### SUMMARY OF THE INVENTION

In order to meet the above requirements, an objective of the present invention is to provide a method and system for terminal devices to log on to a network system that achieves automation of the login allocation process and reduces the number of required login steps and associated time, to allow faster, more efficient management of a network system.

Another objective of the present invention is to provide a method and system for terminal devices to log on to a network system, wherein the name allocation process is not dependent on human intervention, so as to avoid configuration errors and duplication of names as a result of human error, thus making management easier and implementation simpler and more effective.

In order to achieve the above objectives, the present invention provides a terminal device login system applicable to a network comprising server computers and client computers for effective management of login allocation processes for the client computers. The terminal device login system comprises a detecting unit for detecting the presence of a new connection of one of the client computers; a storage unit for storing information related to client computer names; a request unit for requesting an official name assignment from the network; a processing unit for carrying out entire login allocation processes; and a control unit for performing related logic and coordination of said units in the system.

The terminal device login method performed by the terminal device login system comprises the steps as follows. First, when one of the client computers is switched on, the login system quickly detecting and triggering a control program. Then, the control program assigns a temporary computer name to the client computer to allow it to log on the network and requests an official name assignment from the login system. Thereupon, the login system selects an unused official computer name and assigns it to the client computer to replace the temporary name. The client computer updates the computer name with the assigned official computer name for registration to the network. Finally, the client computer restarts and is enabled to operate on the network using the assigned official computer name.

The storage unit can contain information related to all the possible client computer names in a list, and all the computer names already being used in another list. The content of the table can be updated dynamically according to actual conditions on the network or at the system administrator's discretion.

Thus, through the terminal device login method and system provided, effective management of the login allocation of client computer is obtained, achieving fully automated operation and minimizing the required login steps and login time, thus allowing a more efficient and effective login system which avoids the errors that are inevitable in a system requiring human intervention and which also reduces management time and costs.

### BRIEF DESCRIPTION OF THE DRAWINGS

A better understanding of the present invention can be obtained when the foregoing detailed description is considered in conjunction with the following drawings, in which:

FIG. 1 is a schematic block diagram of a terminal device login system of the present invention; and

FIG. 2 is a flow diagram of a terminal system login method of the present invention.

### DETAILED DESCRIPTION OF THE PREFFERED EMBODIMENT

The descriptions below of specific embodiments are intended to illustrate the present invention. Others skilled in the art can readily understand other advantages and features of the present invention from the contents disclosed in this specification. The present invention can be carried out or applied through different embodiments. Details of this specification can be modified based on different viewpoints and applications yet still fall within the scope of the present invention.

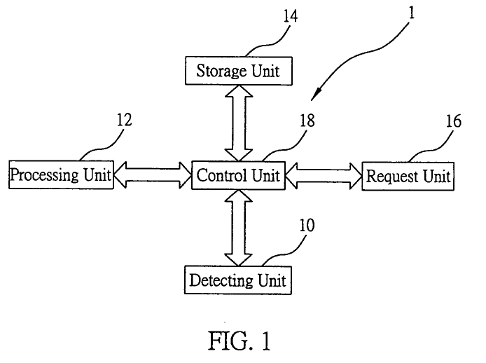

Referring to FIG. 1, which is a system diagram representing the present invention of the terminal device login system, the system at least comprises a detecting unit 10, a processing unit 12, a storage unit 14, a request unit 16, and a control unit 18.

The detecting unit 10 is used to detect whether there is a new client computer connection, and if so, notify the system for further processing. The storage unit 14 is used to store all the information related to the names of the client computers, such as a listing of the currently used computer names and associated parameters and a listing of all the possible computer names and associated parameters, such information typically being stored in tabular form. Alternatively, instead of two listings described above, the storage unit 14 can store a single listing of all the possible computer names with addition parameter to indicate usage/availability of each computer name. The request unit 16 is used to request assignment of an official computer name.

The processing unit 12 is used to carry out all the processes of the entire login procedure, including assignment of temporary names for the client computers requesting login so as to allow them to log on to the network. Then, the processing unit 12, through a selection process, selects an available official computer name to replace the temporary name, allowing the client computer to register on the network in order to perform functional operations. The control unit 18 is used to perform related logic and coordinate the actions of the other elements of the system.

Again referring to FIG. 1, for this specific embodiment, the main application of the present invention is to a Factory Information System (FIS) utilized in the production department of a factory. Before a client computer enters the network system to perform operations, it needs to go through a login allocation process to be assigned an official name on the network, such that it can both send and receive information associated with it or targeted to it, respectively. Once a client computer is switched on and ready to perform operations, the detecting unit 10 will quickly detect the presence of the computer on the network and notify the processing unit 12. The processing unit 12 then produces and assigns a temporary computer name through use of a random, partially random, or deterministic process to allow the client computer to log on the network.

Once the client computer logs on the network with the temporarily assigned name, it then requests the processing unit 12 for an official name assignment through the request unit 16. The processing unit 12, utilizing the storage unit 14, identifies and retrieves an unused computer name. Thereafter, the processing unit 12 assigns the name to the client to register the new client computer as part of the network. Accordingly, once the client computer restarts, it is then able to operate on the network system using the assigned official computer name.

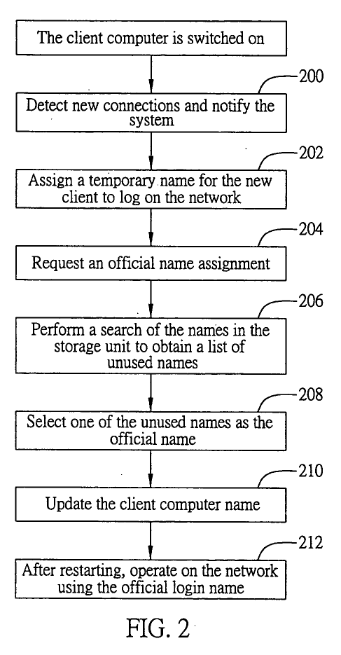

Referring to the flow diagram in FIG. 2, firstly, when the client computer is switched on and initiates a login process, as indicated in flow step 200, the detecting unit 10 will immediately detect the new connection from the client computer, and notify the system to process the additional steps of the method.

Next, in step 202, the processing unit 12 produces a temporary computer name authorizing the client computer to log on the network with the temporary assignment.

Then, in step 204, as the client computer logs on the network with the temporarily assigned name, the request unit 16 makes a request to the processing unit 12 for the official name assignment in order to ultimately perform operations on the network.

Then, the processing unit 12 receives the request sent by the request unit 16, and, in step 206, examines the information relating to the computer names stored in storage unit 14, and retrieves a list of available (not yet used) names in the network system.

Then, in step 208, the processing unit selects a name from the retrieved list of unused names gathered from step 206 and assigns the selected name to the client computer as the computer's official name to be used after the next login to perform operations on the network system.

The client computer then performs an update in step 210, to replace the earlier assigned temporary name with the official computer name as the login name for registration and subsequent network access.

Lastly, in step 212, after the client computer restarts, it then logs on to the network to perform operations with the updated official login name.

During the whole operating cycle of this present invention, the control unit 18 is used to carry out all the related logic and coordinates and controls the timing and interaction of the aforementioned units.

Based on the above description of the terminal login method and system, effective management is obtained for the login name allocation process for the client computers, automated control of login allocations is also achieved, minimizing the number of required login steps and time, and allowing a faster, more effective system login, solving the problems caused by human intervention which result in possible errors and increased costs.

In the present invention, the availability of computer names stored in the storage unit 14 is dynamically updated according to actual status of use.

For this specific embodiment, the proposal to solve the key issues regarding management and assignment of computer names can be further expanded. Another applicable extension could be made to IP address assignments, which can also be done in the automated manner, achieving the purpose of being simple, direct and effective.

While the invention has been described in detail with reference to specific embodiments thereof, it will be apparent to those skilled in the art that various changes and modifications can be made, and equivalents employed, without departing from the spirit and scope of the invention as defined in the following the claims.

What is claimed is:

1. A terminal device login method applicable in a network comprising server computers and client computers for effective management of login allocation processes for the client computers via a terminal device login system, the method comprising:
(1) when one of the client computers being switched on, the login system quickly detecting and triggering a control program;
(2) the control program assigning a temporary computer name for the client computer to log on the network;
(3) the client computer using the temporary name to log on the network and immediately requesting an official name assignment from the login system;
(4) the login system selecting an unused official computer name and assigning it to the client computer to replace the temporary name;
(5) the client computer updating with computer name with the official computer name for registration to the network; and
(6) the client computer restarting and being enabled to functionally operate on the network using the assigned official computer name.

2. The method as claimed in claim 1, wherein the method requires a prior installed hard disc drive (HDD) on the client computer before it logs on the network.

3. The method as claimed in claim 2, wherein the hard disc drive on the client computer is a duplication of a standard system version of hard disk drive.

4. The method as claimed in claim 1, wherein the login system carries out detections regarding the names of the client computers.

5. The method as claimed in claim 1, wherein the system provides an overall summary of the available computer names for selection.

6. The method as claimed in claim 1, wherein the official computer names are dynamically updated based on actual status.

7. The method as claimed in claim 1, wherein the official login names are modified according to client demands.

8. The method as claimed in claim 1, wherein it applies to a master-slave network structure.

9. The method as claimed in claim 1, wherein it is applicable to a Factory Information System (FIS) used in the production department of a factory.

10. A terminal device login system applicable to a network comprising server computers and client computers for effective management of login allocation processes for the client computers, the terminal device login system comprising:
a detecting unit for detecting the presence of a new connection of one of the client computers;
a storage unit for storing information related to client computer names;
a request unit for requesting an official name assignment from the network;
a processing unit for carrying out entire login allocation processes; and
a control unit for performing related logic and coordination of said units in the system.

11. The system as claimed in claim 10, wherein the system requires a prior installed hard disc drive (HDD) on the client computer before it logs on the network.

12. The system as claimed in claim 11, wherein the hard disc drive on the client computer is a duplication of a standard system version of hard disk drive.

13. The system as claimed in claim 10, wherein the detecting unit further performing real-time detection of the conditions relating to each client computer name.

14. The system as claimed in claim 10, wherein the related information stored in the storage unit includes the overall conditions of all possible computer names.

15. The system as claimed in claim 10, wherein the storing in the storage unit is in tabular form.

16. The system as claimed in claim 14, wherein the computer names can be updated dynamically according to actual conditions.

17. The system as claimed in claim 10, wherein the storage unit is a temporary storage device.

18. The system as claimed in claim 10, wherein the processing unit produces a temporary computer name for the client computer to log on the network, and after a retrieval process, selects an unused computer name from the retrieved result as the official computer name of the client computer for subsequent functional operations in the network.

19. The system as claimed in claim 10, wherein the system applies to a master-slave network structure.

20. The system as claimed in claim 10, wherein the system is applicable to the Factory Information System (FIS) used in the production department of a factory.
